(19) United States
(12) Patent Application Publication
(10) Pub. No.: US 2002/0189749 A1
(43) Pub. Date: Dec. 19, 2002

(54) Method for making a cover for a roll core having a multiple layer construction and having minimal residual stresses

(75) Inventor: Yang T. Shieh, Wallingford, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: Advanced Materials Corporation, Lester, PA

(21) Appl. No.: 10/147,753

(22) Filed: May 16, 2002

Related U.S. Application Data
(63) Continuation of application No. 09/573,262, filed on May 18, 2000, now abandoned.

(51) Int. Cl. B29C 65/00

(52) U.S. Cl. 156/172; 156/187; 156/285; 156/305

(57) ABSTRACT

A method is disclosed for producing a covered roll having a multi-layered construction. A first embodiment includes a plurality of steps. The first step is to provide a cylindrical roll core having two ends, a length therebetween, and an outer surface. Next, a dry fiber mat layer is tightly wrapped over the roll core outer surface. A fabric, in the form of a strip, is impregnated with a thermoset resin such as epoxy or urethane. The roll core is then rotated and the thermoset resin impregnated fabric strip is helically wound over the tightly wrapped dry fiber mat layer. Tension is maintained while winding the thermoset resin impregnated fabric strip to form a fabric layer.

### RELATED APPLICATIONS

This application claims priority under 35 U.S.C. §120 of U.S. patent application Ser. No. 09/573,262, filed on May 18, 2000, which in turn claims priority from U.S. patent application Ser. Nos. 09/362,430 and 09/363,328 both filed on Jul. 28, 1999.

### BACKGROUND OF THE INVENTION

Covers for roll cores are used in demanding industrial environments such as paper mills and are subjected to high temperatures, corrosive chemicals and dynamic loads. In a typical paper mill, large numbers of covered rolls are utilized for transporting web sheets which become paper as well as for processing these web sheets into finished paper. It is essential that these covered rolls be precisely balanced and include surfaces that maintain specific configurations and tight tolerances. Calendering is a process utilized within a paper mill for improving the smoothness, gloss, printability and thickness of paper. Covered rolls utilized in these calendering processes, usually referred to as calender rolls, super-calendar rolls or soft nip calendar rolls are subjected to high dynamic loads. As previously mentioned, a calender roll actually contributes to the processing of the paper rather than merely transporting the web through the paper mill machinery. In order to function properly, a calendar roll must have a surface of a predetermined hardness of a high degree. In the past, epoxy resins cured at relatively high temperatures, have been utilized as covers for calendar rolls because they achieve the mechanical and thermal properties necessary for utilization in this application. To obtain a cover for a calender roll having higher thermal resistance, it is necessary to employ a higher curing temperature. However, curing at such high temperatures causes a considerable amount of residual stress which causes these calendar roll covers to crack, delaminate or lift at their edges rendering them unusable. Excessive residual stresses can also reduce the life cycle of a roll cover or lead to premature local failures. Thus, there is a need to develop methods for fabricating covers for calender rolls that result in reduced residual stresses while achieving sufficient hardness to resist high dynamic loads.

Careful consideration must be given to the heating and curing steps performed during the fabrication of roll covers because these steps, in addition to the selection of the resin system employed, contribute most significantly to the development of residual stresses. Often, residual stresses develop in roll core covers because of a mismatch in the thermal expansion properties between the cover materials and the material utilized in the roll core when these materials are bonded together. These stresses can also develop where several cover materials are utilized together having different thermal expansion properties. Residual stresses can also develop as a result of chemically related cross-link shrinkage. One prior teaching suggests that one way to alleviate residual stresses is to cast the cover separately and let it cool to a lower temperature prior to bonding it to a metal core also at a lower temperature than the casting temperature. Thus, the thermal stresses that would arise from cooling from the cure temperature or that would arise from cross-linking shrinkage would be reduced. Although adhesives are available for bonding the cover to the metal core at lower temperatures, often, these adhesives do not perform well at high temperatures. Even worse, these adhesives, usually formed resins, can generate considerable residual stresses due to the fact that they have a thickness of their own. The casting method also requires that an open cavity and mold be created between the cover and the roll core which necessitates multiple process steps. Thus, there is a need to develop methods to reduce residual stresses in covers for roll cores.

### OBJECTS OF THE INVENTION

Accordingly, it is a general object of this invention to provide a method and apparatus for covering a roll core that overcomes the disadvantages of prior art cover materials.

It is a further object of this invention to provide a method and apparatus for covering a roll core with an epoxy resin material or other suitable thermoset resin such as urethane as the outer layer.

It is a further object of this invention to provide a method and apparatus for covering a roll core wherein the cover has minimal residual stresses.

It is a further object of this invention to provide a method and apparatus for covering a roll core wherein the cover effectively adheres to the metal outer surface of the roll core it covers.

It is a further object of this invention to provide a method and apparatus for covering a roll core that results in a covering having a high tensile strength.

It is a further object of this invention to provide a method and apparatus for covering a roll core that results in a covering having a more suitable Young's modulus.

It is a further object of this invention to provide a method and apparatus for covering a roll core wherein the cover has a high glass transition temperature.

It is a further object of this invention to provide a method and apparatus for covering a roll core wherein the cover has a high durability and long lifespan.

It is a further object of this invention to provide a method and apparatus for covering a roll core that is less expensive than prior art methods and devices.

It is a further object of this invention to provide a method and apparatus for covering a roll core that results in a cover that performs consistently under extremely high pressures, high heating conditions and high speed conditions.

It is a further object of this invention to provide a method and apparatus for covering a roll core wherein the cover has a high compression strength.

It is a further object of this invention to provide a method and apparatus for covering a roll core wherein the covering has a high impact strength.

It is a further object of this invention to provide a method for covering a roll core that is shorter in fabrication time than the prior art methods.

### SUMMARY OF THE INVENTION

The present invention discloses a method for producing a cover for a roll core, the cover having a multi-layered, construction. A first embodiment includes a plurality of steps. The first step is to provide a cylindrical roll core having two ends, a length therebetween, and an outer surface. Next, a dry fiber mat layer is tightly wrapped over the roll core outer surface. A fabric, in the form of a strip, is impregnated with an epoxy resin or other suitable thermoset materials such as urethane. The roll core is then rotated and the thermoset resin impregnated fabric strip is helically wound over the tightly wrapped dry fiber mat layer. During wrapping, the resin impregnated strip approaches but does not reach the ends of the roll core to allow for shrinkage in the axial direction. Tension is maintained while winding the resin impregnated fabric strip to form a fabric layer. The resin in the fabric layer is then cured. Next, a thermoset resin such as epoxy, urethane or polyvinyl ester, is infused through the cured fabric layer and into the dry fiber mat layer.

In a variation of the first embodiment, prior to the step of tightly wrapping the dry fiber mat layer over the roll core outer surface, the roll core is placed in a substantially horizontal orientation.

In another variation of the first embodiment, prior to the step of infusing the resin material, the roll core is tilted to a non-horizontal orientation.

In another variation of the first embodiment, the step of infusing a resin material into the dry fiber mat layer includes the sub-steps of drilling entrance holes into the roll proximate the bottom end thereof which extend through the fabric layer and into the dry fiber mat layer, sealing the roll at the bottom end thereof with a sealing material, and injecting a thermoset resin through those entrance holes and into the dry fiber mat layer.

In another variation of the first embodiment, following the step of drilling entrance holes into the roll, the method comprises the further step of drilling at least one vacuum hole into the roll proximate the top end thereof which extends through the fabric layer and into the dry fiber mat layer.

In another variation of the first embodiment, the step of drilling further includes the sub-steps of inserting valves into the entrance holes and into the at least one vacuum hole and connecting a vacuum source to the at least one vacuum hole.

In another variation of the first embodiment, following the step of placing the roll in a substantially horizontal orientation, the method comprises the further step of locating an extension segment on each end of the roll core, each extension segment comprising an outer circumference substantially the same as the outer circumference of the roll core.

In another variation of the first embodiment, the step of tightly wrapping a dry fiber mat layer over the roll core outer surface further includes the sub-step of tightly wrapping the fiber mat layer over the extension segments located at the ends of the roll core.

In another variation of the first embodiment, the step of helically winding the fabric strip tightly about the outer surface of the roll core further includes the sub-step of helically winding the fabric strip tightly over the outer surface of the extension segments located at the ends of the roll core.

In another variation of the first embodiment, following the step of locating extension segments on the ends of the roll core, the method comprises the further step of shot blasting the entire roll core outer surface and extension segments located thereon.

In another variation of the first embodiment, following the step of shot blasting, the method comprises the further step of brushing on a chemical solution.

In another variation of the first embodiment, prior to the step of locating an extension segment on each end of the roll core, the method comprises the further step of removing all greases and oils present on the roll core outer surface by utilizing organic solvents and solutions.

In another variation of the first embodiment, the step of feeding a thermoset resin through the entrance holes further includes the sub-steps of activating a vacuum source and allowing the thermoset resin to flow into the dry fiber mat layer until it seeps out a vacuum hole and thereafter deactivating the vacuum source.

In another variation of the first embodiment, following the step of deactivating the vacuum source, the method comprises the further steps of sealing all entrance holes, sealing the at least one vacuum hole and allowing the thermoset resin to gel for a predetermined period of time.

In another variation of the first embodiment, following the step of allowing the thermoset resin to gel for a predetermined period of time, the method comprises the further steps of returning the roll core to a substantially horizontal orientation, placing the roll core in an oven and curing the roll core for a predetermined period of time at a predetermined temperature that is somewhat higher than the operational temperature of the cover of the finished roll core so that residual stresses are minimized when the finished covered roll core is placed into operation.

In another variation of the first embodiment, the step of curing further includes the sub-step of rotating the covered roll core.

In another variation of the first embodiment, following the curing step, the method comprises the further step of machining the outside surface of the covered roll core to a predetermined diameter and smoothness.

In another variation of the first embodiment, following the step of machining the outside surface of the covered roll core, the method comprises the further step of severing the coated roll core at its ends to remove the extension segments therefrom.

In another variation of the first embodiment, prior to the step of tightly wrapping a dry fiber mat layer over the roll core outer surface, the method comprises the further step of applying an adhesive to the roll core outer surface.

In another variation of the first embodiment, the fabric strip is formed of glass fibers.

In another variation of the first embodiment, the fabric strip is formed of KEVLAR® fibers.

In another variation of the first embodiment, the fabric strip is wound over the tightly wrapped dry fiber mat layer in such a manner that the convolutions of the fabric strip are substantially parallel to each other, extend substantially perpendicular to the longitudinal axis of the roll core, and have a longitudinal edge overlapping the adjacent longitudinal edge of the immediately preceding turn. Under this variation, the wound fabric strip approaches but does not reach the ends of the roll core.

In another variation of the first embodiment, prior to the step of impregnating a fabric in the form of a strip with a thermoset resin, the method comprises the further step of helically winding the fabric strip in a dry state over the tightly wrapped dry fiber mat layer while rotating the roll core and maintaining the dry fabric strip under tension.

In another variation of the first embodiment, the step of helically winding a dry fabric strip includes winding for two passes over the entire length of the roll core and wherein the step of helically winding the impregnated fabric strip includes winding two passes over the entire length of the roll core.

### DESCRIPTION OF THE DRAWINGS

Other objects and many attendant features of this invention will become readily appreciated as the same becomes better understood by reference to the following detailed description when considered in connection with the accompanying drawings wherein:

FIG. 1 is a side view of a roll core being covered in accordance with the present invention and shown therein held at its ends within a turning mechanism;

FIG. 2 is a top view illustrating the method of covering a roll core of the present invention in which a fabric strip is shown being applied to the roll core by helical winding;

FIG. 3 is a side view of a roll core covered in accordance with the present invention showing the fabric layer helically wound over a portion of the fiber mat layer;

FIG. 4 is a sectional view taken along line 4-4 of FIG. 3;

FIG. 5 is a sectional view of a metal roll core covered with a fiber mat under layer and a resin impregnated fabric outer layer in accordance with the present invention;

FIG. 6 is an enlarged view of the encircled area of FIG. 5;

FIG. 7 is a partial sectional view of a roll core covered in accordance with the present invention which illustrates a method for infusing resin material into the dry fiber mat underlayer in accordance with the present invention;

FIG. 8 is an enlarged view of the encircled area of FIG. 7;

FIG. 9 is a side view of a roll core covered in accordance with the present invention and held at its ends within a turning mechanism situated within a curing oven;

FIG. 10 is a side view of a roll core covered in accordance with the present invention being held at its ends within a turning mechanism and machined to a predetermined smoothness;

FIG. 11 is a view demonstrating wrapping of the dry fiber mat underlayer to the metal roll core by utilizing a carrier mat in accordance with the present invention;

FIG. 12 is an isometric view of a portion of a covered roll core having a beveled end formed in accordance with the present invention; and,

FIG. 13 is a cross-sectional view of a metal roll core covered in accordance with a second embodiment of the present invention.

### DETAILED DESCRIPTION OF THE PREFERRED EMBODIMENTS

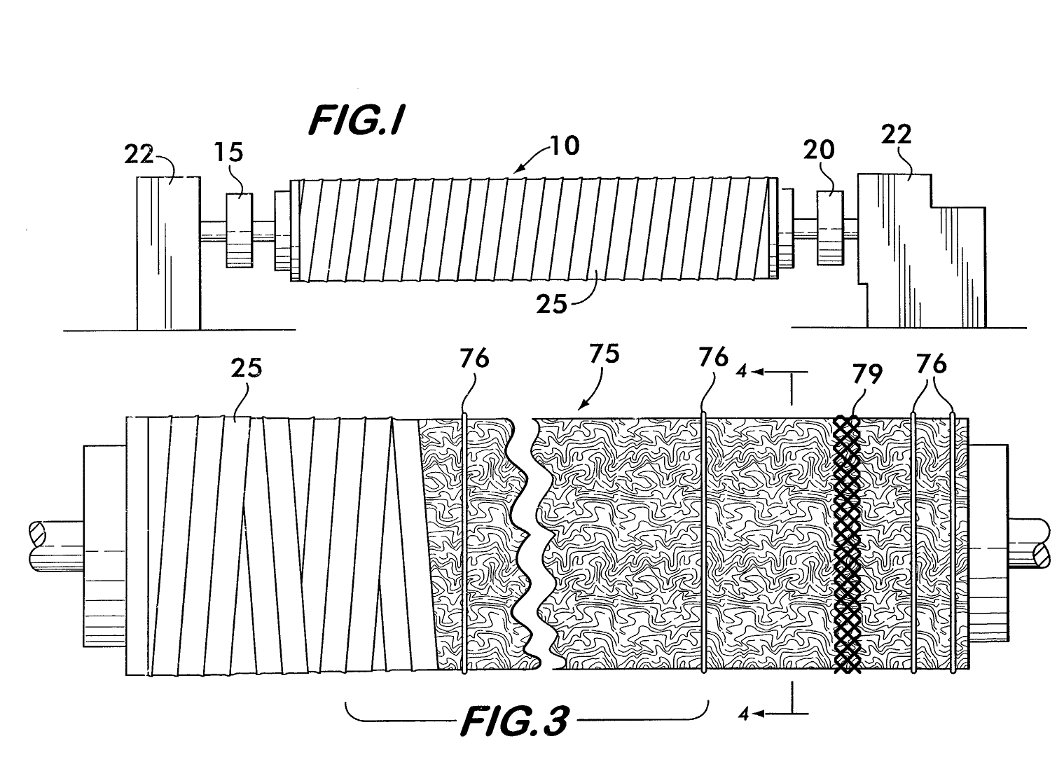

Referring now in greater detail to the various figures of the drawings wherein like reference numerals refer to like parts there is shown at 10 in FIG. 1, a roll core covered in accordance with the method of the present invention. As shown in FIG. 1, the covered roll core is shown positioned between the opposing universal chucks 15 and 20 of a turning apparatus, e.g., an engine lathe 22. The universal chucks 15 and 20 are aligned to assure substantially horizontal orientation of the roll core while the roll core is rotated along its longitudinal axis during the fabrication of a fabric layer 25, which forms a portion of the cover of the present invention. Application of the fabric layer 25, which is applied over a previously applied fiber mat layer 75, will be described later in this application.

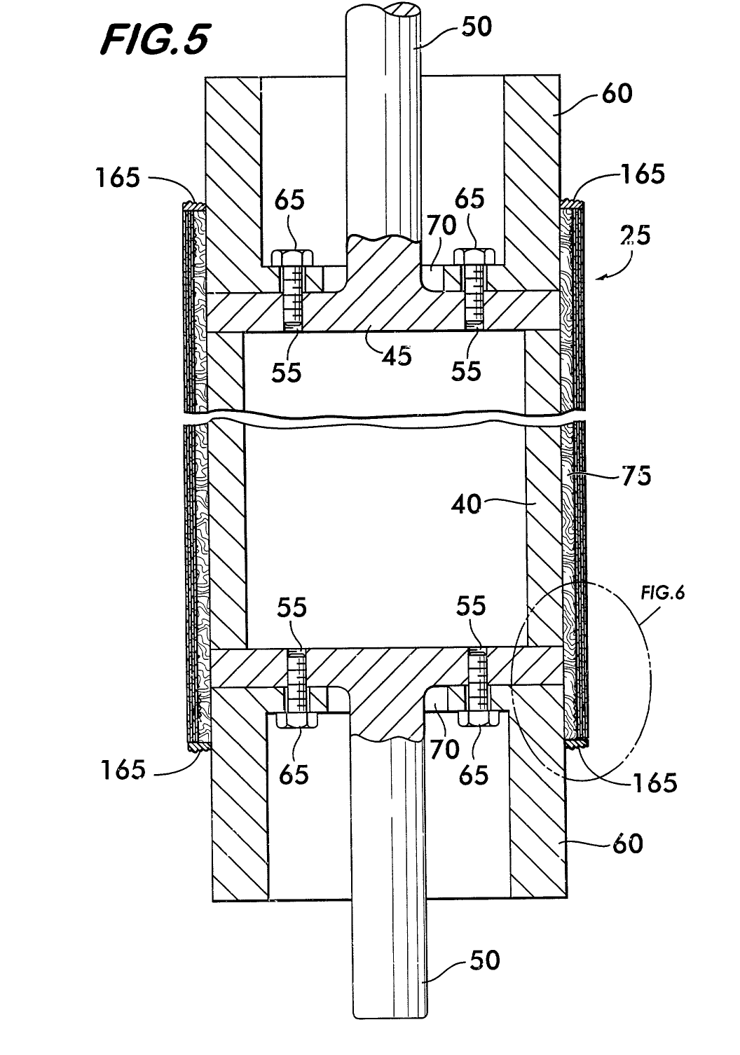

Referring now to FIG. 5, the metal roll core, shown at 40, is of a predetermined length and is generally cylindrical in shape and includes a central axis and an outer surface formed of any suitable material, e.g., metal. The metal roll core 40 additionally comprises end caps 45 that are secured to the ends thereof by any suitable means. The end caps 45 have a circumference approximately the same as that of the roll core and include journals 50 that are concentric with the central axis of the metal roll core 40 and enable securement of the metal roll core 40 within the opposed universal chucks 15 and 20 (FIG. 1). The end caps 45 are provided with threaded openings 55 to enable the attachment of extension segments 60 thereto by any suitable means, e.g., bolts 65. Each extension segment 60 is provided with a circumference approximately equal to that of the metal roll core 40 and further comprises a central opening 70 for disposition of the extension segment 60 over the journal 50 to enable attachment of the extension segment 60 to the end cap 45. At this juncture, it is important to mention that the extension segments 60 shown in the figures and the manner in which they are illustrated as attaching to the roll core end caps 45 is merely exemplary. There are a variety of differently constructed extension segments that may be adapted to enable attachment to roll cores in a variety of ways. A gasket (not shown) may be inserted between the extension segment 60 and the end cap 45 to assure an airtight seal therebetween.

At the start of the process, a spent roll core 40 is returned from a customer such as a paper mill, textile mill or magnetic film manufacturer where such covered rolls are utilized in manufacturing finished products. The roll core is returned from the customer with the cover substantially consumed and, therefore, a new cover must be applied. First, after remaining cover material has been physically removed, the outer surface of the roll core 40 must be thoroughly cleaned in ways known to those practiced in this art to remove all remaining cover material. The cleaning process includes degreasing or removing all greases and/or oils remaining on the outer surface of the roll core 40 by utilizing known solvents and solutions. After the degreasing step, the extension segments 60 are fixedly secured to the ends of the roll core 40 in the manner described above.

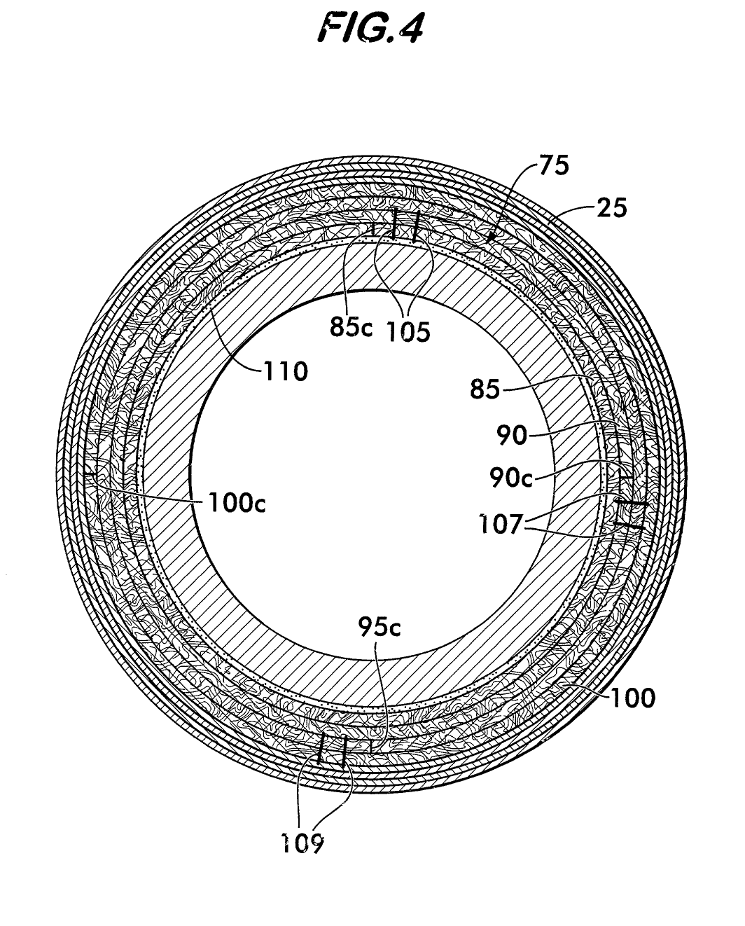

Next, the entire outer surface of the roll core 40 with the extension segments 60 fixedly secured thereto is shot blasted for the purpose of removing all rust, dirt and remaining roll cover materials. After shot blasting, a chemical solution is brushed onto the freshly shot blasted outer surface of the roll core 40 in ways known to those practiced in the art. The chemical solution facilitates oxidation of the outer surface of the roll core 40 to enhance its adhesion with epoxy which will be applied as a primer, and/or infused into a fiber mat layer 75 later in the process. Next, a layer of liquid epoxy primer 110 (FIG. 4) is applied over the entire outer surface of the roll core 40 to enable adhesion with the dry fiber mat layer 75 which is tightly wrapped thereover.

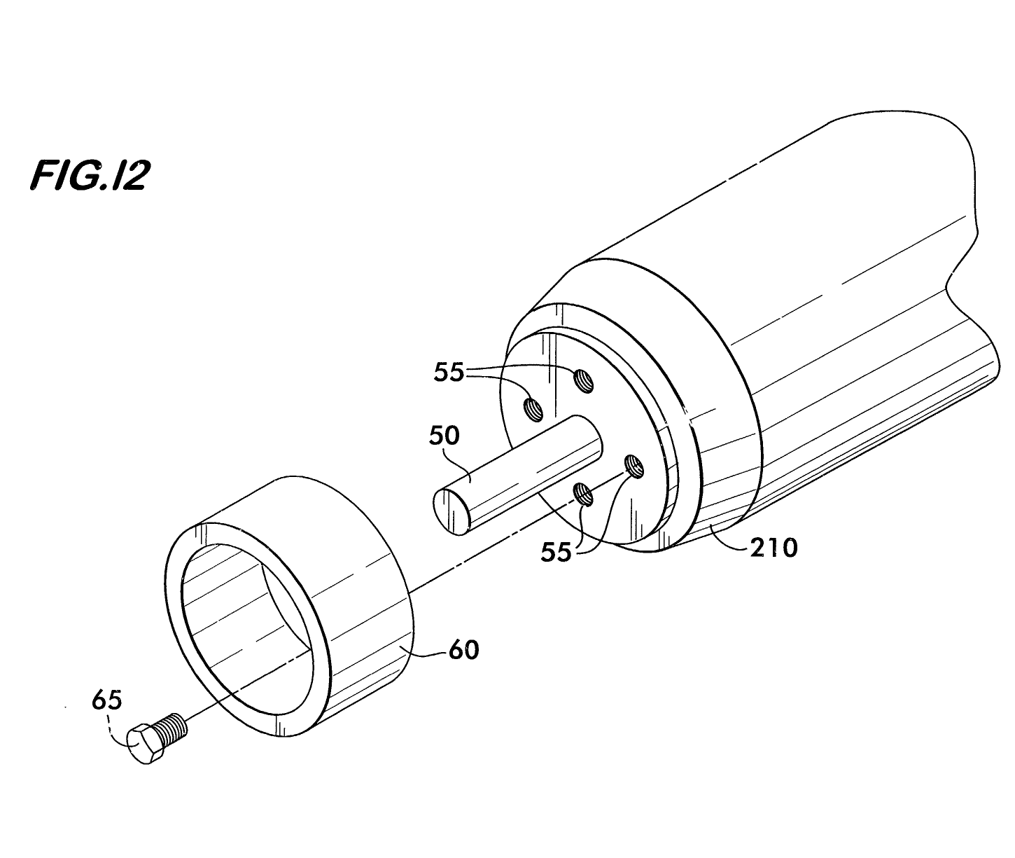

The process for fabricating and tightly wrapping the fiber mat layer 75 over the outer surface of the roll core 40 will now be discussed in detail as a typical case for utilizing the method and apparatus of the present invention. FIG. 11 best illustrates the steps involved in the formation of the fiber mat layer 75. As shown therein, the fiber mat layer 75 comprises a plurality of sub-layers of glass fiber material including an inside sub-layer 85, a second sublayer 90, a third sub-layer 95, and an outside sub-layer 100. The second sub-layer 90 is affixed near its leading edge 90a to the inside sub-layer 85 by any suitable means, e.g., stitches 105, located approximately three-quarters of the way along the length of the inside sub-layer 85 from the leading edge 85a thereof to form a seam. Likewise, the third sub-layer 95 is affixed near its leading edge 95a to the second sub-layer 90 by any suitable means, e.g., stitches 107, located approximately three-quarters of the way along the length of the second sub-layer 90 from the leading edge 90a thereof to form a seam. Finally, the outside sub-layer 100 is affixed near its leading edge 100a to the third sub-layer 95 by any suitable means, e.g., stitches 109, located approximately three-quarters of the way along the length of the third sub-layer 95 from the leading edge 95a thereof to form a seam.

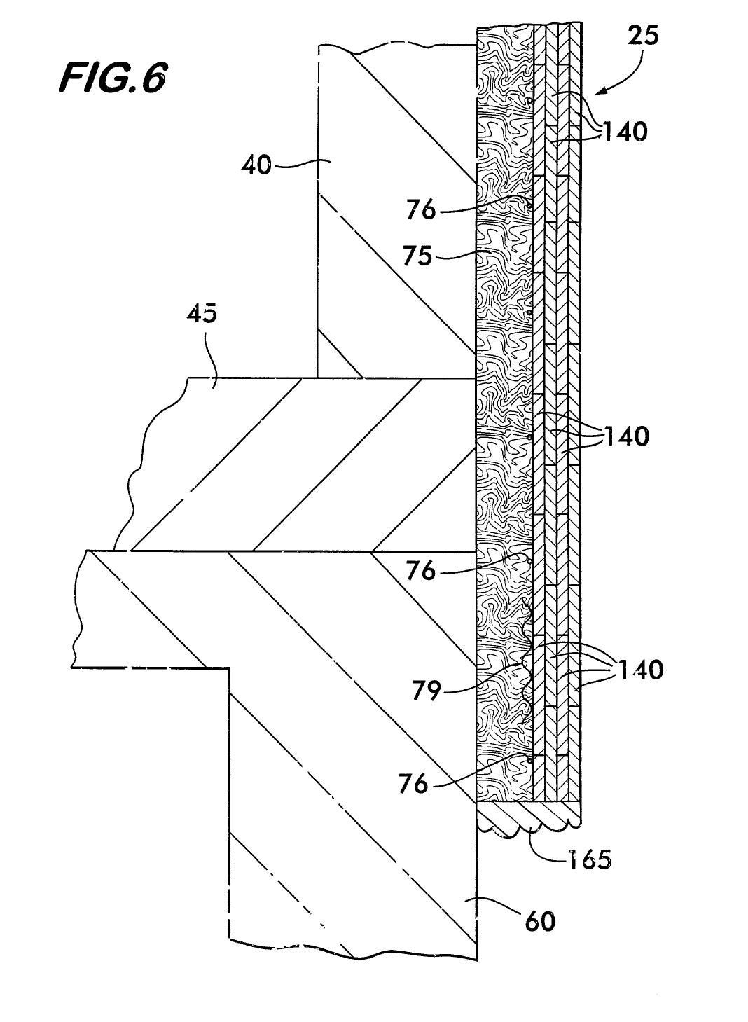

As best shown in FIG. 11, the roll core 40 is oriented horizontally for the wrapping thereover of the various sub-layers to form the fiber mat layer 75. At this juncture it is important to mention that the fiber mat layer 75 is applied over the roll core 40 outer surface tightly under high pulling tension in a dry condition and without the addition of any epoxy resin thereto. It is not until after the fabric layer 25 is applied over the previously applied fiber mat layer 75 that liquid epoxy resin is infused through the fabric layer 25 and into the dry fiber mat layer 75 and allowed to cure therein. The manner for infusing the epoxy resin will be explained in detail below. As best shown in FIG. 5 and in the detailed FIG. 6, the fiber mat layer 75 extends beyond the ends of the roll core 40 and extends over a portion of the extension segments 60 fixedly secured at both ends thereof.

Still referring to FIG. 11, prior to applying the leading edge 85a of the inside sublayer 85 to the roll core 40, the outer surface of the roll core 40 is primed with epoxy 110. Thereafter, the leading edge 85a of the inside sub-layer 85 is unwound from a spool 115 in the direction indicated by arrow 117 and conveyed over a roller 120 where it is thereafter tightly wrapped onto the roll core 40 outer surface. During application of the fiber mat layer 75, the roll core 40 rotates in the direction indicated by arrow 121. Simultaneously, a length of carrier material 125, e.g., paper, wound on a dispensing roller 130 is unspooled therefrom and conveyed with the inside sub-layer 85 and eventually, the remaining sub-layers of the fiber mat layer 75, over the roller 120. The carrier material 125 travels with the various sub-layers of the fiber mat layer 75 as the fiber mat layer 75 wraps around a major portion of the roll core 40 outer surface. In this manner, the carrier material 125 acts to support the fiber mat layer 75 and assures a tight wrap over the roll core 40 outer surface. The carrier material 125 is directed away from the roll core 40 outer surface by a second roller 130 and is taken up on a take-up roller 135. At this juncture, it is important to mention that under the embodiment being described herein, no preheating of the roll core outside surface is necessary.

Referring now to FIGS. 4 and 11, the length of the inside sub-layer 85, measured from its leading edge 85a to its trailing edge 85b, is approximately equal to the circumference of the roll core 40 outer surface such that when the inside sub-layer 85 is applied thereon, its trailing edge 85b comes into abutting relation with its previously applied leading edge 85a. The abutment of edges 85a and 85b is best shown in FIG. 4 at 85c. The second sub-layer 90 is slightly greater in length than the inner sub-layer 85 such that when the second sub-layer 90 is applied over the inner sub-layer 85, its trailing edge 90b comes into abutting relation with its leading edge 90a. The abutment of the edges 90a and 90b is shown in FIG. 4 at 90c. Likewise, the third sub-layer 95 is slightly greater in length than the second sub-layer 90 such that when the third sub-layer 95 is applied over the second sub-layer 90, its trailing edge 95b comes into abutting relation with its leading edge 95a. The abutment of the edges 95a and 95b is shown in FIG. 4 at 95c. Likewise the abutment of the edges 100a and 100b of the outside sub-layer 100 is shown in FIG. 4 at 100c. The leading and following edges 100a and 100b of the outside sub-layer 100 are affixed to each other by any suitable means, e.g., stitching. By wrapping in this manner, the abutting seam of each sub-layer 85c, 90c, 95c and 100c are spaced well away from each other and evenly around the roll core 40 outer surface rather than being stacked atop one another. Stacking of the stitched seams on top of one another may result in an irregularity forming on the outer layer thickness of the finished roll core. The resulting fiber mat layer 75 is between 0.25 and 0.32 inches in thickness and preferably 0.30 inches in thickness. The fiber mat layer 75 may be of any suitable construction and preferably is made of glass fibers, carbon fibers, aramid fibers (e.g., KEVLAR® fibers), or other mineral/metallic high strength fibers.

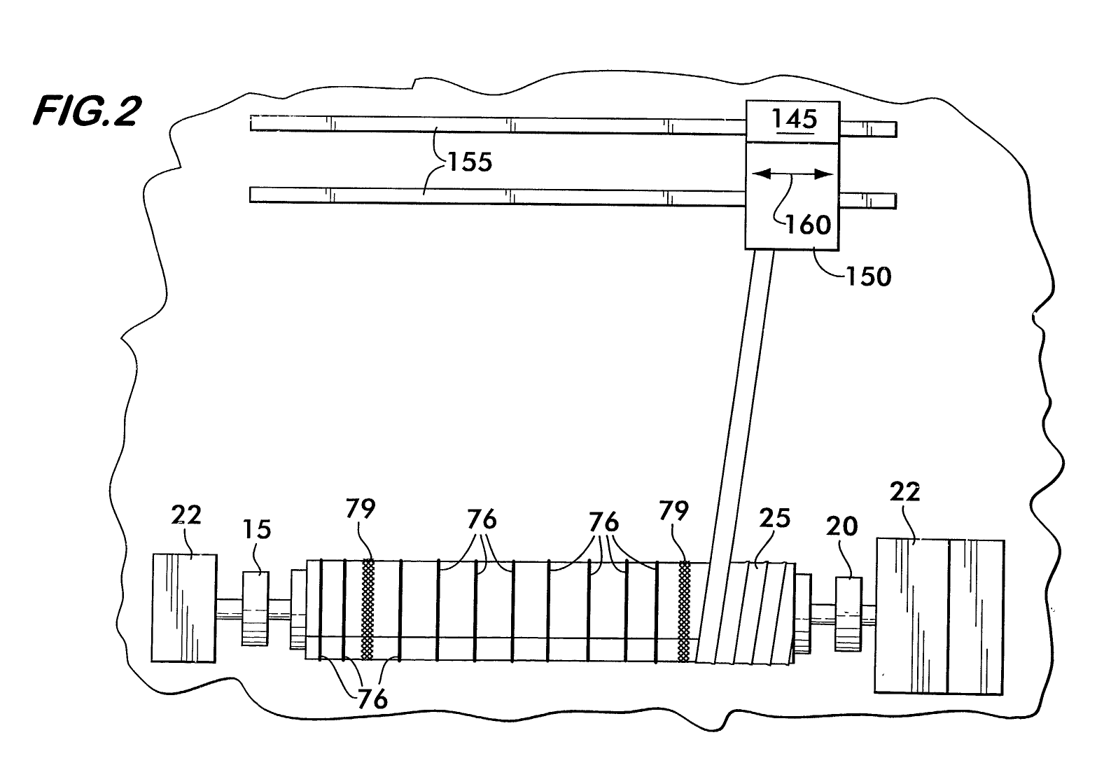

The number of layers of fiber mat 75 and its structures and materials, as well as thickness can be engineered differently for different applications. For example, a second embodiment of the fiber mat layer 77 of the present invention is illustrated in FIG. 13. The fiber mat layer 77 illustrated therein comprises a single layer rather than a plurality of sub-layers as previously described. The length of the single layer 77, measured from its leading edge to its trailing edge, is approximately equal to the circumference of the roll core 40 outer surface such that when the single layer 77 is applied thereon, its trailing edge comes into abutting relation with its leading edge. The abutment of these edges is best shown in FIG. 13 at 77c. Referring now to FIG. 2, once the fiber mat layer 75 has been applied to the roll core, the mat 75 is tightly secured to the roll core 40 by utilizing a plurality of ties indicated at 76 and 79. The ties 76 and 79 are also indicated in cross-section in FIG. 6.

The next step in the process is to apply the fabric layer 25 over the previously applied fiber mat layer 75. Again referring to FIG. 2, the roll core 40 with the fiber mat layer 75 secured thereto is shown positioned between the opposing universal chucks 15 and 20 of the engine lathe 22. The universal chucks 15 and 20 are aligned to assure substantially horizontal orientation of the roll core 40 while the roll core is rotated along its longitudinal axis. Rotation of the roll core 40 causes a strip of dry fabric 140, several inches in width, to be un-spooled from a reel 145, conveyed through a bath 150 containing a liquid thermoset resin such as epoxy, and wound over the fiber mat layer 75 secured to the roll core. The bath 150 is maintained at a predetermined temperature. Other resins such as urethane may be utilized in the bath 150.

At this juncture, it is important to mention that although the epoxy bath 150 and reel 145 are illustrated in FIG. 2 as being parts of an integral assembly, this is not necessary nor a requirement and these two components may be separate. In FIG. 2, the epoxy bath 150 and reel 145 are shown both situated on a pair of parallel elongated slots or tracks 155 thus enabling movement of the epoxy bath 150 and reel 145 in back and forth reciprocating directions as indicated by the arrows 160. This enables the epoxy impregnated fabric strip 140 to be helically wound over the entire length of the roll core 40 in a back and forth fashion. The wrapping process is continued back and forth to achieve a specified thickness which in this case is a thickness of approximately 15 mm which takes place in four passes using a KEVLAR® strip that is approximately 1.75 mm in thickness and approximately 50.8 mm wide and overlapping by 50%.

As best shown in FIG. 6, each subsequent wrap of the fabric strip 140 overlaps a portion of the previous wrap. The amount of overlap can be varied based upon customer requirements. As best shown in FIG. 5 and in the detailed FIG. 6, the fabric layer 25 extends beyond the ends of the roll core 40 and actually extends over a portion of the extension segments 60 fixedly secured at both ends thereof. In applying the fabric strip 140 to the roll core 40, the number of back and forth passes of the fabric strip 140 determines the resulting thickness of the fabric layer 25. In some instances it may be desirable to apply several initial passes, e.g., one or two, of the fabric strip 140 to the roll core 40 in its dry condition rather than first passing it through the epoxy resin bath. In this manner, the portion of the fabric strip 140 applied in its dry condition serves as a penetration barrier to prevent leakage of epoxy applied to the remaining portion of the fabric strip into the fiber mat layer 75. The epoxy is then allowed to cool and cure to form a layer.

The fiber mat layer 75 is dry and therefore somewhat compressible when the fabric layer 25 is applied thereover. This compressibility enables the fabric layer 25 to be cured at temperatures that are somewhat higher than curing temperatures utilized in the prior art teachings without obtaining appreciable residual stresses. A higher cure temperature is desirable to obtain a cover having a higher hardness and higher glass transition temperature (T_{g}). A cover having a higher degree of hardness and higher glass transition temperature can be utilized in more demanding applications and at higher temperatures when put into service. This is a desirable characteristic of covers fabricated in accordance with the present invention. Also, under the present invention, a wider range of resins having higher glass transition temperatures may be selected and employed for demanding cover applications. The fabric layer 25 may be of any suitable construction that may include glass fibers or KEVLAR® fibers or carbon fiber. Since the fiber mat layer 75 underlying the fabric layer 25 is still in its dry condition, i.e., it has not yet been infused with epoxy resin, the fiber mat layer 75 is somewhat compressible in both radial and axial directions and thus able to reduce any stresses that could arise during the cross-linking and cooling of the epoxy resin. Thus, under the present invention, it is possible to fabricate a cover for a roll core having a high degree of hardness, a high glass transition temperature, minimal residual stresses and that bonds well to the roll core.

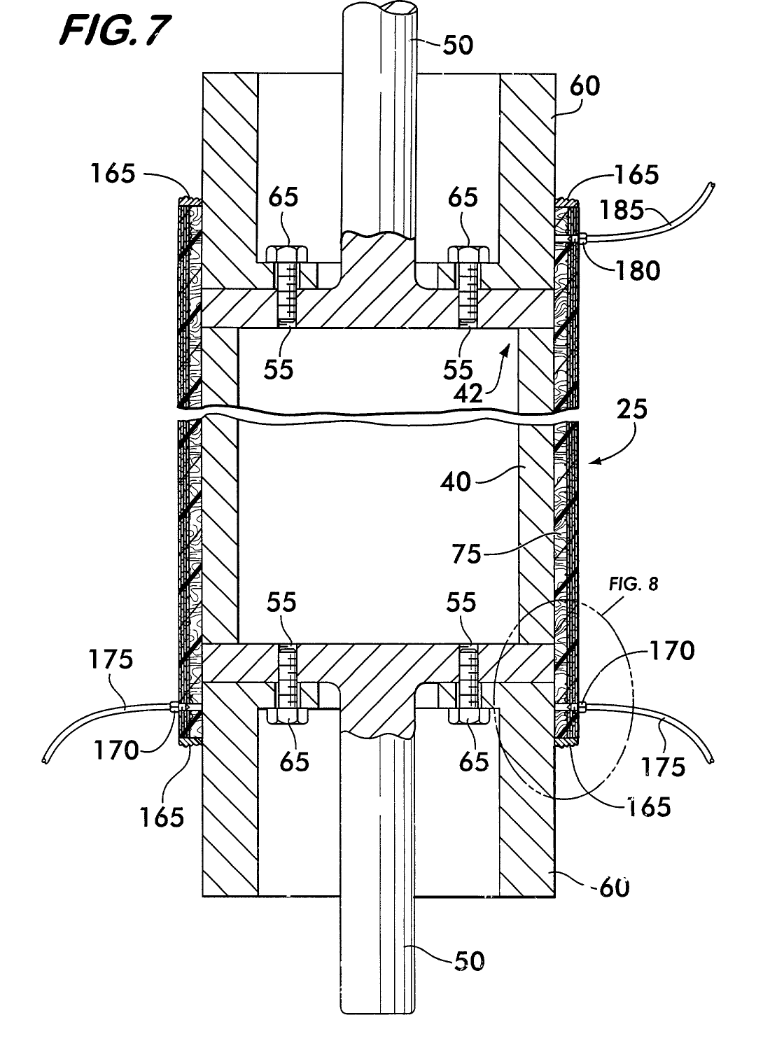

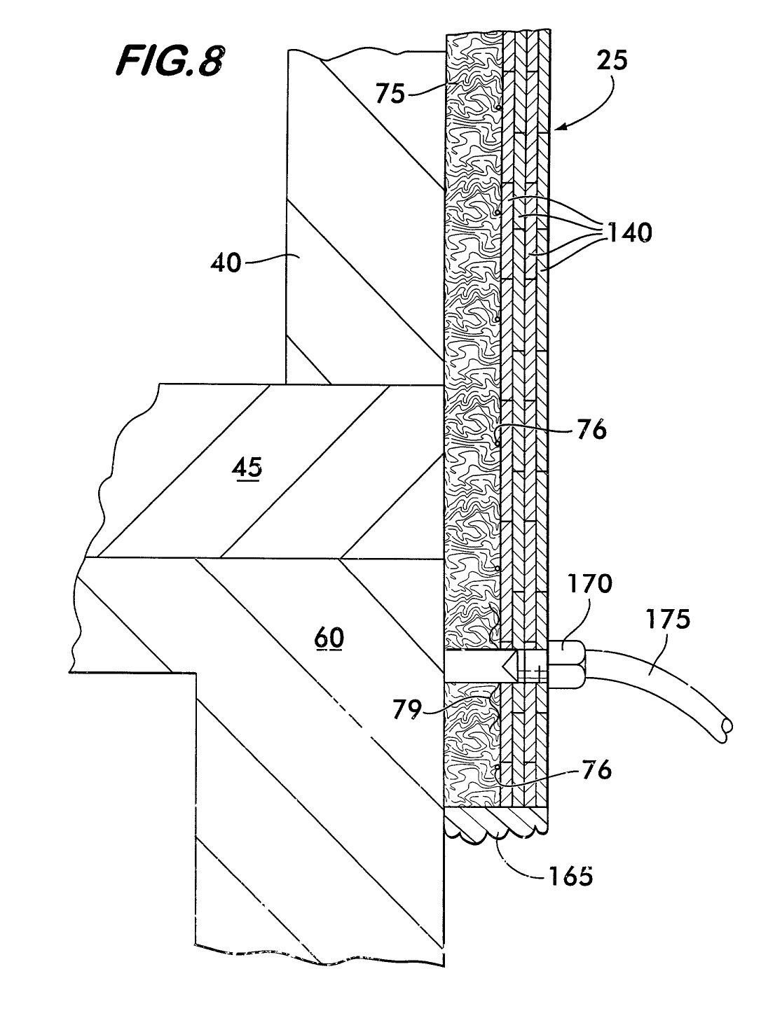

Referring now to FIGS. 7 and 8, the roll core 40 with the fiber mat layer 75 and the fabric layer 25 applied thereover is moved from its substantially horizontal position to a vertical position for the infusion of epoxy through the fabric layer 25 and into the fiber mat layer 75. Once oriented in this vertical position as shown in these figures, the roll core 40 includes a bottom end 41 and a top end 42. Prior to epoxy infusion, a length of sealant 165 is applied to the fabric layer 25 and fiber mat layer 75 at both ends 41, 42 of the roll core 40. The sealant 165 is provided to prevent the leakage of epoxy resin that may result from downward gravitational movement of the epoxy resin during the infusion process. As shown in FIGS. 7 and 8, a plurality of holes are drilled through the fabric layer 25 and into the interior of the fiber mat layer 75. In particular, a plurality of entrance holes are drilled proximate the roll core bottom 41 (best shown in FIG. 7) at the locations shown therein and a plurality of entrance valves 170 are inserted therethrough. The entrance valves 170 are each connected to lines 175 through which the epoxy resin is fed (or supplied). A similar valve 180 is inserted through a vacuum hole drilled proximate the roll core top 42. The vacuum valve 180 is connected to a vacuum source by a vacuum line 185 and a vacuum is pulled. The epoxy resin is fed (or supplied) through the entrance valves 170 and infuses through the fabric layer 25 after a predetermined vacuum is reached. The previously applied sealant 165 provides vacuum enclosure and prevents the epoxy resin from leaking downwardly. Maintaining the level of the vacuum valve 180 above that of the entrance valves 170 assures that air bubbles within the fiber mat layer 75 will escape through the vacuum valve 180 during epoxy resin infusion. Eventually, the epoxy resin seeps out of the vacuum valve 180. When this occurs, all valves 170 and/or 180 are closed. The epoxy resin is then allowed to gel at room temperature for a predetermined period of time, e.g., twelve to twenty-four hours.

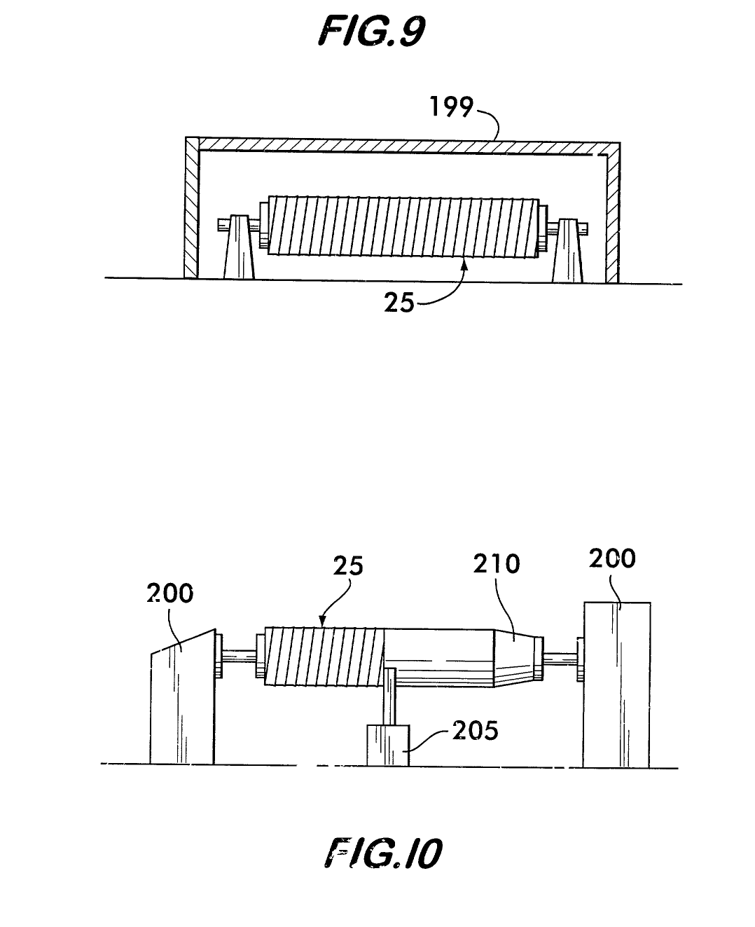

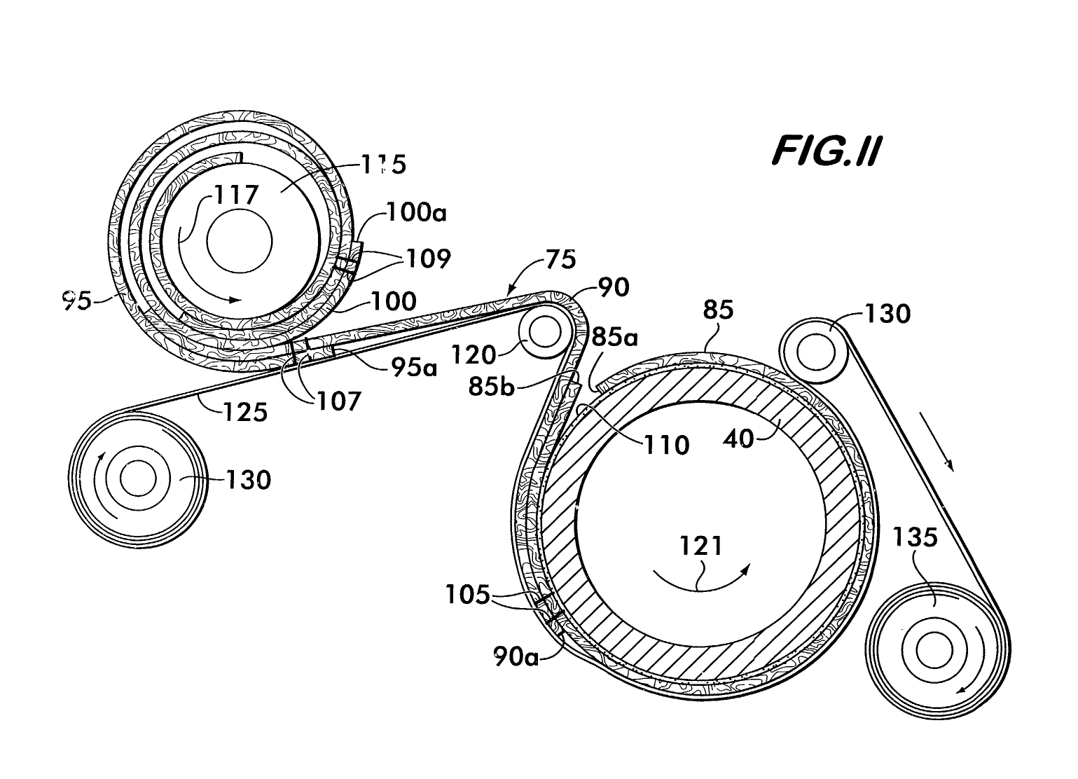

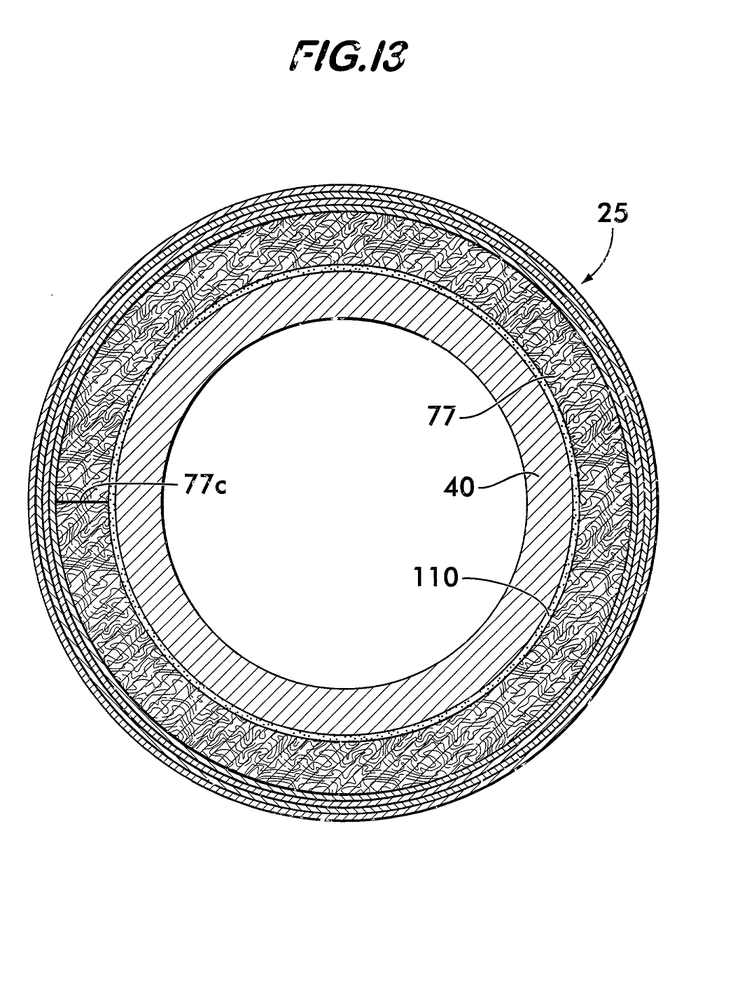

Referring now to FIG. 9, after the infusion process, the roll core is moved from its vertical position placed back to its substantially horizontal position within an oven 199 for curing of the epoxy resin while being rotated. The curing temperature is approximately 30° F. higher than the temperatures the resulting cover will be exposed to when put into service. By utilizing a curing temperature that is slightly higher than the operating temperature of the resulting covered roll, overall residual stress is minimized, thus extending the life and strength of the resulting covered roll. As shown in FIG. 9, after the epoxy resin has cured, the fabric layer 25 is machined to a desired diameter and smoothness. Referring now to FIG. 10, this may be accomplished by placing the covered roll core horizontally on a lathe 200 and machining the outer surface of the fabric layer 25 to a predetermined smoothness utilizing a suitable cutting tool 205. A super finish process, if necessary, may be applied to obtain an extremely high surface smoothness of 0 Ra micro-inch. Next, the cutting tool 205 may be utilized to cut through the fabric layer and the fiber mat layer 75 down to the roll core 40 outer surface at each end of the roll core for removal of the extension segments 60 from each end thereof. As best shown in FIGS. 10 and 12, utilizing the cutting tool 205, the edges of the covered roll may be treated to form a slight bevel 210, which is currently known in the art, to obtain a finished roll that may be returned to the customer. A typical finished covered roll fabricated under the method of the present invention may have a diameter of 20 inches and a length of 150 inches and possesses a combination of improved performance characteristics including: a surface roughness of between 0 and greater than 0 Ra, a Young's modulus of between 350,000 and 15M p.s.i., a cover hardness between 86 to 93 Shore D, and a glass transition temperature, T_{g}, of approximately 350° F.

I claim:

1. A method for producing a covered roll, the covered roll having a multi-layered, construction, said method comprising the steps of:
a. providing a cylindrical roll core, the roll core having two ends, a length therebetween, and an outer surface;
b. tightly wrapping a dry fiber mat over the roll core outer surface;
c. impregnating a fabric in the form of a strip with a thermoset resin;
d. helically winding said impregnated fabric strip over the tightly wrapped dry fiber mat while rotating said roll core and maintaining said fabric strip under tension to form a fabric layer;
e. curing said thermoset resin; and,
f. infusing a filler material into the dry fiber mat layer.

2. A method as in claim 1 wherein prior to said step of tightly wrapping a dry fiber mat over a substantial portion of the roll core outer surface, said method comprises the further step of placing the roll in a substantially horizontal orientation.

3. A method as in claim 2 wherein prior to said step of infusing a filler material, said method comprises the further step of tilting the roll core to a non-horizontal orientation, the roll core oriented as such including a bottom end and a top end.

4. A method as in claim 3 wherein said step of infusing a filler material into the dry fiber mat layer includes the sub-steps of:
a. drilling entrance holes into the roll proximate the bottom end thereof which extend through the fabric layer and into the dry fiber mat layer;
b. sealing the roll at the bottom end thereof with a sealing material; and,
c. feeding a thermoset resin through those entrance holes and into the dry fiber mat layer.

5. A method as in claim 4 wherein following said step of drilling entrance holes into the roll, said method comprises the further step of drilling at least one vacuum hole into the roll proximate the top end thereof which extends through the fabric layer and into the dry fiber mat layer.

6. A method as in claim 5 wherein said step of drilling further includes the sub-steps of:
a. inserting valves into the entrance holes and into the at least one vacuum hole; and,
b. connecting a vacuum source to the at least one vacuum hole.

7. A method as in claim 2 wherein following said step of placing the roll in a substantially horizontal orientation, said method comprises the further step of locating an extension segment on each end of the roll core, each extension segment comprising an outer circumference substantially the same as the outer circumference of the roll core.

8. A method as in claim 7 wherein said step of tightly wrapping a dry fiber mat layer over the roll core outer surface further includes the sub-step of tightly wrapping the fiber mat layer over the extension segments located at the ends of the roll core and wherein said step of helically winding said fabric strip tightly about the outer surface of said roll core further includes the sub-step of helically winding said fabric strip tightly over the outer surface of the extension segment located at the ends of the roll core.

9. A method as in claim 7 wherein following said step of locating extension segments on the ends of the roll core, said method comprises the further step of shot blasting the entire roll core outer surface and extension segments located thereon.

10. A method as in claim 9 wherein following said step of shot blasting, said method comprises the further step of brushing on a chemical solution.

11. A method as in claim 7 wherein prior to the step of locating an extension segment on each end of the roll core, said method comprises the further step of removing all greases and oils present on the roll core outer surface by utilizing organic solvents and solutions.

12. A method as in claim 4 wherein said step of feeding a thermoset resin through the entrance holes further includes the sub-steps of:
a. activating a vacuum source and allowing the thermoset resin to flow into the dry fiber mat layer until it seeps out the at least one vacuum hole; and,
b. thereafter deactivating the vacuum source.

13. A method as in claim 12 wherein following said step of deactivating the vacuum source, said method comprises the further steps of sealing all entrance holes, sealing the at least one vacuum hole and allowing the thermoset resin to gel for a predetermined period of time.

14. A method as in claim 13 wherein following said step of allowing the thermoset resin to gel for a predetermined period of time, said method comprises the further steps of returning the roll core to a substantially horizontal orientation, placing the roll core in an oven and curing the roll core for a predetermined period of time.

15. A method as in claim 14 wherein said step of curing further includes the sub-step of rotating the covered roll core.

16. A method as in claim 15 wherein following said curing step, said method comprises the further step of machining the outside surface of the covered roll core to a predetermined diameter and smoothness.

17. A method as in claim 16 wherein following said step of machining the outside surface of the covered roll core, said method comprises the further step of severing the coated roll core at its ends to remove the extension segments therefrom.

18. A method as set forth in claim 1, wherein prior to said step of tightly wrapping a dry fiber mat layer over the roll core outer surface, said method comprises the further step of applying an adhesive to the roll core outer surface.

19. A method as set forth in claim 1, wherein said fabric strip is formed of glass fibers.

20. A method as set forth in claim 1, wherein said fabric strip is formed of KEVLAR® fibers.

21. A method as in claim 1 wherein said fabric strip is wound over the tightly wrapped dry fiber mat layer in such a manner that the convolutions of said fabric strip are substantially parallel to each other, extend substantially perpendicular to the longitudinal axis of said roll core, and have a longitudinal edge overlapping the adjacent longitudinal edge of the immediately preceding turn.

22. A method as in claim 1 wherein prior to said step of impregnating a fabric in the form of a strip with a thermoset resin, said method comprises the further step of helically winding the fabric strip in a dry state over the tightly wrapped dry fiber mat layer while rotating said roll core and maintaining said dry fabric strip under tension.

23. A method as in claim 22 wherein said step of helically winding the dry fabric strip includes winding for two passes over the entire length of said roll core and wherein said step of helically winding said impregnated fabric strip includes winding for two passes over the entire length of said role core.

24. A method as in claim 22 wherein said step of helically winding a dry fabric strip includes winding for one pass over the entire length of said roll core and wherein said step of helically winding said impregnated fabric strip includes winding for three passes over the entire length of said role core.

25. A method as in claim 1 wherein said fiber mat layer comprises glass fibers.

26. A method as in claim 1 wherein said fiber mat layer comprises carbon fibers.

27. A method as in claim 1 wherein said fiber mat layer comprises aramid fibers.

28. A method as in claim 1 wherein said thermoset resin is an epoxy resin.

29. A method as in claim 1 wherein said thermoset resin is urethane.

30. A method as in claim 21 wherein the convolutions of said fabric strip overlap by a degree of approximately 50%.

31. A method as in claim 21 wherein the convolutions of said fabric strip overlap by a degree of approximately 0%.

32. A method as in claim 21 wherein the convolutions of said fabric strip overlap by a degree of approximately 90%.

33. A method as in claim 21 wherein the convolutions of said fabric strip overlap by a degree of between approximately 0% and approximately 90%.

34. A method as in claim 1 wherein the covered roll is in tended to be exposed to a predetermined operational temperature when placed into service and wherein said step of curing said thermoset resin is done at a temperature higher than said predetermined operational temperature.

35. The method as in claim 34 wherein said step of curing is done at a temperature approximately 30° F. higher than said predetermined operational temperature.
